(19) United States
(12) Patent Application Publication
(10) Pub. No.: US 2006/0027026 A1
(43) Pub. Date: Feb. 9, 2006

(54) Sensor device

(75) Inventors: Seiki Aoyama, Toyohashi-city (JP); Takaaki Kawai, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/188,878

(22) Filed: Jul. 26, 2005

(30) Foreign Application Priority Data
Aug. 4, 2004 (JP) 2004-227843

(51) Int. Cl. G01B 7/16

(52) U.S. Cl. 73/777

(57) ABSTRACT

A sensor device includes a circuit chip and a sensor chip adhesively stacked on the circuit chip through a film type adhesive material. Stress moderation film for moderating stress applied to the circuit chip may be interposed between the circuit chip and the film type adhesive material.

### CROSS REFERENCE TO RELATED APPLICATION

This application is based upon, claims the benefit of priority of, and incorporates by reference the contents of Japanese Patent Application No. 2004-227843 filed on Aug. 4, 2004.

### FIELD OF THE INVENTION

The present invention relates to a sensor device in which a sensor chip is stacked on a circuit chip through a film type adhesive material.

### BACKGROUND OF THE INVENTION

As this type of sensor device has been proposed an acceleration sensor or an angular velocity sensor which comprises a circuit chip and a sensor chip stacked on the circuit chip, the circuit chip and the sensor chip being adhesively attached to each other through a film type adhesive agent (for example, see JP-A-2002-5951).

FIG. 4 is a diagram showing a general cross-sectional construction of this type of sensor device. A sensor chip 30 is an acceleration sensor chip, an angular velocity sensor chip or a pressure sensor chip which comprises a semiconductor chip or the like, and this sensor chip 30 is stacked on a circuit chip 20 having a function of processing a signal from the sensor chip 30.

Furthermore, a film type adhesive material 40 formed of thermosetting resin, thermoplastic resin or the like is interposed between both the chips 20 and 30, and both the chips 20 and 30 are adhesively fixed to each other through the film type adhesive material 40.

Both the chips 20 and 30 are mounted in a package case 10 by fixing the circuit chip 20 to the package case 10. Both the chips 20 and 30 are electrically connected to each other by bonding wires or the like (not shown). Furthermore, as shown in FIG. 4, the circuit chip 20 and the package case 10 are also electrically connected to each other by bonding wires 50.

The sensor device as described above can be manufactured as follows. That is, the sensor chip 30 is mounted through the film type adhesive material 40 onto the circuit chip 20 fixed to the package case 10, and the sensor chip 30 is pressurized so as to be pressed against the circuit chip 20. As occasion demands, the sensor chip 30 is adhesively attached to the circuit chip 20 while heated. Thereafter, wire bonding is carried out and then a lid 11 is secured to the package case 10.

Here, when the sensor chip 30 is mounted on the circuit chip 20, foreign materials K1 such as silicon scraps of the semiconductor chip, scraps of other constituent parts or the like may be wedged between the sensor chip 30 and the circuit chip 20.

In this case, when the sensor chip 30 is pressurized so as to be pressed against the circuit chip 20, that is, when the film type adhesive material 40 is pressurized, the foreign materials K1 are pressed against the circuit chip 20 below the film type adhesive material 40, so that the circuit chip 20 is damaged.

Specifically, as shown in FIG. 4, the surface of the circuit chip 20 is normally coated by protection film 21 such as silicon nitride film (SiN) or the like, and stress concentration from the foreign materials to the circuit chip occurs due to thermal stress caused by variation of pressure or temperature environment when the circuit chip 20 is mounted. Therefore, cracks of the protection film 21 progress or the circuit elements below the protection film 21 are damaged, and finally breakdown of the circuit chip 20 may occur.

### SUMMARY OF THE INVENTION

In view of the foregoing problem, it is an object to provide a sensor device having a sensor chip adhesively stacked on a circuit chip through a film type adhesive material in which the circuit chip serving as a base is prevented from being damaged even when a foreign material invades between the sensor chip and the circuit chip.

In order to attain the above object, according to a first aspect, a sensor device comprising a circuit chip and a sensor chip adhesively stacked on the circuit chip through a film type adhesive material is characterized in that stress moderation film for moderating stress applied to the circuit chip is interposed between the circuit chip and the film type adhesive material.

According to the sensor device descried above, the stress moderation film for moderating the stress applied to the circuit chip is interposed between the circuit chip and the film type adhesive material, and even when a foreign material exists between the sensor chip and the circuit chip, the stress concentration from the foreign material to the circuit chip by thermal stress caused by variation of pressure or temperature environment when the sensor chip is mounted on the circuit chip can be moderated.

Accordingly, in the sensor device in which the sensor chip is stacked and adhesively attached onto the circuit chip through the film type adhesive material, even when a foreign material intrudes between the sensor chip and the circuit chip, the circuit chip serving as a base can be prevented from being damaged.

According to a second aspect, in the sensor device of the first embodiment, it is preferable that the stress moderation film is softer than the protection film coated on the surface of the circuit chip.

According to a third aspect, in the sensor device described above, the stress moderating film may be formed of resin film.

According to a fourth aspect, a sensor device comprising a circuit chip and a sensor chip adhesively stacked on the circuit chip through a film type adhesive material is characterized in that the thickness of the film type adhesive material is set to be larger than the size of foreign materials occurring in a process of manufacturing the sensor device.

According to the above sensor device, the thickness of the film type adhesive material is set to be larger than the size of foreign materials occurring in the process of manufacturing the sensor device concerned, and thus when the sensor chip is pressurized while pressed against the circuit chip, the foreign materials are taken into the large-thickness film type adhesive material, and thus the stress applied from the foreign materials to the circuit chip can be greatly reduced.

Accordingly, in the sensor device in which the sensor chip is stacked and adhesively attached onto the circuit chip through the film type adhesive material, even when foreign materials intrude between the sensor chip and the circuit chip, the circuit chip serving as a base can be prevented from being damaged.

According to a fifth aspect, in the sensor device of the fourth aspect of the invention, the thickness of the film type adhesive material may be set to 20 μm or more.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross-sectional view showing an acceleration sensor device as a sensor device according to a first embodiment;

FIGS. 2A and 2B are diagrams showing a planar shape of stress moderation film and a film type adhesive material which are formed on a circuit chip;

FIG. 3 is a cross-sectional view showing an acceleration sensor device as a sensor device according to a second embodiment; and

FIG. 4 is a diagram showing a general cross-sectional structure of a conventional sensor device.

### DETAILED DESCRIPTION OF THE PREFERRED EMBODIMENTS

Preferred embodiments will be described hereunder with reference to the accompanying drawings. In the following embodiments, the same or equivalent parts are represented by the same reference numerals to simplify the description.

### First Embodiment

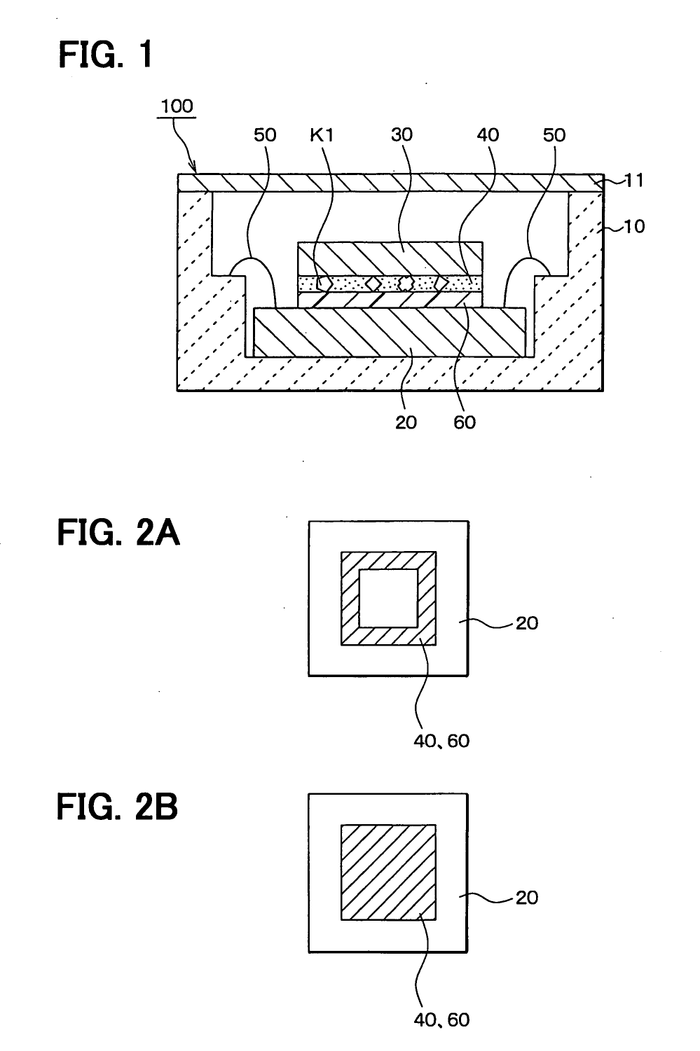

FIG. 1 is a cross-sectional view showing an acceleration sensor device 100 as a sensor device according to a first embodiment.

The acceleration sensor device 100 may be mounted in a vehicle and used to control the driving of the vehicle, for example. In FIG. 1, foreign materials K1 existing between a sensor chip 30 and a circuit chip 20 is illustrated.

In FIG. 1, a ceramic package case 10 serves as a base portion of the acceleration sensor device 100, and it is used to secure the acceleration sensor device 100 to a suitable position of a measurement target. As not shown, the ceramic package case 10 is formed by stacking a plurality of layers formed of aluminum or the like and then forming wires on the surface thereof or at the inside thereof, and it enables the acceleration sensor device 100 to be electrically connected to the outside through these wires.

Furthermore, a circuit chip 20 is mounted on the ceramic package case 10 through adhesive agent such as silicone-based resin or the like as shown in FIG. 1, for example. The sensor chip 30 is stacked on the upper surface of the circuit chip 20 through the film type adhesive material 40. Here, as the film type adhesive material 40 may be used a resin material which can exhibit an adhesive function when it is pressurized and hardened. Specifically, as the film type adhesive material 40 may be used silicone group, epoxy group, polyimide group, acryl group, urethane group, rubber group, liquid crystal polymer or the like.

The sensor chip 30 is constructed as a detecting element for detecting acceleration, and it may be constructed by forming a generally known beam structure member having a comb-shaped structure on a silicon substrate or the like so as to detect variation of the electrostatic capacitance (electrical signal) occurring between a movable electrode and a fixed electrode in accordance with an applied acceleration.

Furthermore, as the circuit chip 20 may be used a circuit which is formed by forming MOS transistors, bipolar transistors or the like on a silicon substrate or the like through a well-known semiconductor process, and has a function of processing an electrical signal from the sensor chip 30 and outputting the processing result or the like.

The sensor chip 30 and the circuit chip 20, and the circuit chip 20 and the ceramic package case 10 are electrically connected to each other through bonding wires 50 formed of gold, aluminum or the like.

In FIG. 1, bonding wires for connecting the sensor chip 30 and the circuit chip 20 are omitted, and bonding wires 50 for connecting the circuit chip 20 and the ceramic package case 10 are shown.

As described above, the electrical signal (capacitance variation) from the sensor chip 30 is transmitted to the circuit chip 20, and it is converted to a voltage signal by a CN conversion circuit or the like provided to the circuit chip 20 and output as an acceleration signal.

Here, in this embodiment, stress moderation film 60 for moderating stress applied to the circuit chip 20 is interposed between the circuit chip 20 and the film type adhesive material 40 as shown in FIG. 1.

It is preferable that the stress moderation film 60 is softer than protection film coated on the surface of the circuit chip 20. The protection film of the circuit chip 20 is formed of silicon nitride film (SiN) or the like by deposition sputtering or the like, and resin film or the like may be used as the stress moderation film 60, for example.

Considering the film properties of the stress moderation film 60 of this embodiment, the hardness and thickness of the stress moderation film 60 are considered as factors to transmit acceleration like an acceleration sensor. Here, when attention is paid to materials which can be manufactured in the semiconductor process, specifically, polyimide film which is formed by a spin coat method or the like can be used as the stress moderation film 60. Furthermore, when no attention is paid to the semiconductor process, thermosetting resin which can be subjected to screen printing, for example, epoxy resin or the like can be used as the stress moderation film 60.

With respect to the thickness of the stress moderation film 60, in consideration of the size of foreign materials occurring in the manufacturing process, for example, scraps of silicon occurring from chip edges may range from about several μm to 20 μm in size.

Therefore, the stress moderation film 60 is required to have such a film thickness that it can endure the size of silicon scraps existing as the foreign materials K1 (see FIG. 1) on the circuit chip 20 and the pressure applied when the film type adhesive material 40 is pressurized and adhesively fixed. As the thickness of the stress moderation film 60 is larger, the resistance to the foreign materials (that is, the protection performance of the circuit chip 20) is more increased. However, in consideration of the acceleration transmission performance in the acceleration sensor device 100 and the easiness of the manufacturing in the semiconductor process, the thickness of the stress moderation film 60 may be set in the range from 1 μm to 30 μm, and the optimal value thereof is set to 10 to 20 μm in consideration of the size of foreign materials.

Furthermore, FIGS. 2A and 2B are diagrams showing the planar shape of the stress moderation film 60 and the film type adhesive material 40 which are formed on the circuit chip 20. In this case, the stress moderation film 60 and the film type adhesive material 40 are illustrated as being hatched.

With respect to the planar shape of the stress moderation film 60 and the film type adhesive material 40, in a case where some degree of thickness can be secured as the thickness of the stress moderation film 60 and a film having a thickness larger than the size of foreign materials can be formed, if the planar shape of the stress moderation film 60 and the film type adhesive material 40 is set to a hollow square pattern like a square frame as shown in FIG. 2A, the area of a site which damages the circuit chip 20 is reduced, and thus the effect is more enhanced.

However, if the planar shape of the stress moderation film 60 and the film type adhesive material 40 is set to a square pattern as shown in FIG. 2B, it would be preferable in the point that the contact area is larger than that of the hollow square pattern and the adhesion strength can be secured.

Therefore, the planar shape of the stress moderation film 60 and the film type adhesion material 40 is designed in consideration of the relationship between the reduction in area of a portion damaging the circuit chip and the securement of the adhesion strength which are in trade-off relationship.

Furthermore, with respect to the surface state of the stress moderation film 60, the adhesion is carried out on the surface of the stress moderation film 60 through the film type adhesion material 40, and it is preferable to secure high adhesion performance that the surface of the stress moderation film 60 is kept substantially uniformly flat.

Furthermore, a stack body achieved by stacking the sensor chip 30 on the circuit chip 20 through the film type adhesive material 40 as described above is mounted in the ceramic package case 10, and a lid 11 is secured to the opening portion of the ceramic package case 10. The inside of the ceramic package case 10 is sealed by the lid 11.

The acceleration sensor device 100 as described above can be manufactured as follows.

First, the adhesive agent is coated on the ceramic package case 10, the circuit chip 20 is installed in the ceramic package case 10 through the adhesive agent, and then the adhesive agent is hardened. The stress moderation film 60 is formed on the surface of the circuit chip 20 in advance.

Subsequently, the sensor chip 30 is installed, and there are two methods of installing the sensor chip 30. According to one method, a film type adhesive material 40 is attached to a wafer which will serve as sensor chips, and then dicing-cut is carried out on the wafer while the film type adhesive material 40 is attached, thereby segmenting the wafer into sensor chips 30. Each sensor chips 30 thus segmented is picked up and mounted on a circuit chip 20. According to another method, dicing-cut is carried out on a wafer which will serve as sensor chips, and sensor chips 30 thus segmented are achieved. Furthermore, a film type adhesive material 40 is cut out in the same size as the sensor chip 30. Thereafter, the film type adhesive material 40 and the sensor chip 30 are successively mounted on the circuit chip 20 in this order.

After the sensor chip 30 is mounted on the circuit 20 through the film type adhesive material 40 according to any one of the above methods, actual curing is carried out on the stack body thus achieved to stabilize the adhesion power of the film type adhesive material 40 and enhance the durability.

Thereafter, wire bonding is carried out by using wire rods of gold, aluminum or the like to form the bonding wires 50. Then, the lid 11 is secured to the package case 10, whereby the acceleration sensor device 100 shown in FIG. 1 is completed.

According to this embodiment, in the sensor device 100 in which the sensor chip 30 is stacked and adhesively attached onto the circuit chip 20 through the film type adhesive material 40, the stress moderation film 60 for moderating the stress applied to the circuit chip 20 is interposed between the circuit chip 20 and the film type adhesive material 40.

According to the sensor device 100, the stress moderation film 60 for moderating the stress applied to the circuit chip 30 is interposed between the circuit chip 20 and the film type adhesive material 40, and thus even when foreign materials K1 exist between the sensor chip 30 and the circuit chip 20, the stress concentration from the foreign materials K1 to the circuit chip 20 due to thermal stress caused by variation of the pressure or temperature environment in the mounting step can be moderated.

Accordingly, according to this embodiment, in the sensor device 100 in which the sensor chip 30 is stacked and adhesively attached onto the circuit chip 20 through the film type adhesive material 40, the circuit chip 20 serving as a base can be prevented from being damaged even when the foreign materials K1 intrude between the sensor chip 30 and the circuit chip 20.

In this embodiment, it is preferable that the stress moderation film 60 is softer than the protection film coated on the surface of the circuit chip 20, and specifically, it may be formed of resin film.

### Second Embodiment

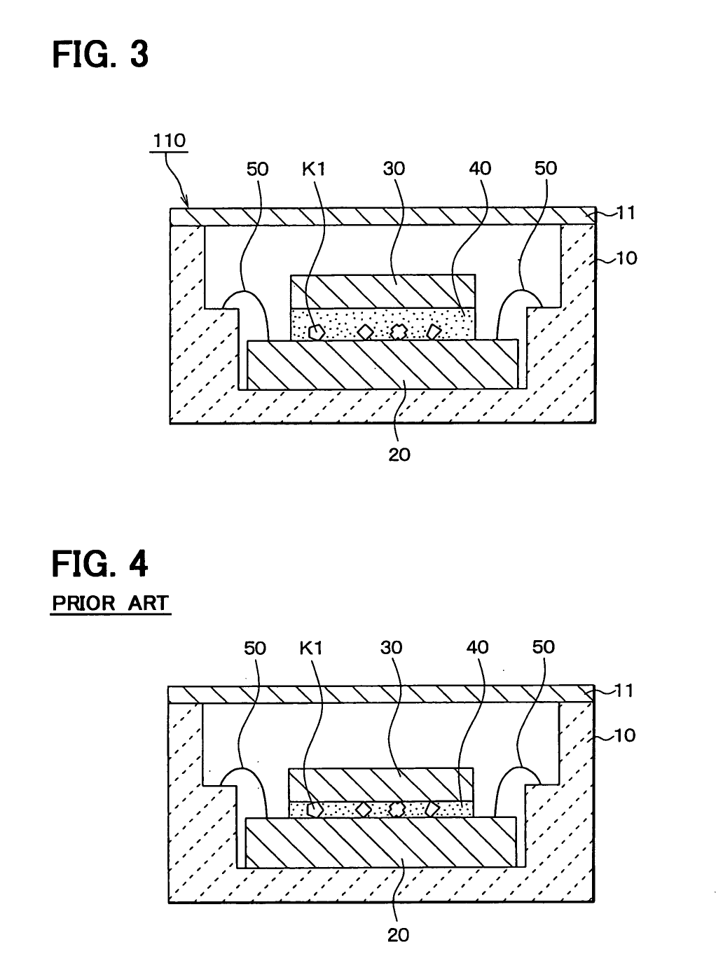

FIG. 3 is a cross-sectional view showing an acceleration sensor device 110 as a sensor device according to a second embodiment. In FIG. 3, foreign materials K1 existing between a sensor chip 30 and a circuit 20 are also illustrated. The different point from the first embodiment will be mainly described.

In the first embodiment, the stress moderation film 60 is interposed between the circuit chip 20 and the film type adhesive material 40 in order to prevent the circuit chip 20 serving as a base from being damaged even when the foreign materials K1 intrude between the sensor chip 30 and the circuit chip 20. On the other hand, according to the second embodiment, in order to have the same effect as the first embodiment, no stress moderation film 60 is interposed, however, the thickness of the film type adhesive material 40 is set to be larger than the size of the foreign materials K1 occurring in the process of manufacturing the sensor device 110 as shown in FIG. 3.

The size of the foreign materials K1 occurring in the process of manufacturing the sensor device corresponds to the size of each foreign material occurring in the semiconductor process or existing in a clean room because the sensor device is normally manufactured in the clean room.

With respect to the thickness of the film type adhesive material 40, values achieved in consideration of silicon scraps as the foreign materials K1 (see FIG. 3), that is, 20 μm or more is considered as the optimal values as in the case of the first embodiment. Furthermore, in consideration of a range that has no adverse effect on the acceleration transmission performance and also does not cause cost-up, about 50 μm may be considered as the upper limit value.

Furthermore, with respect to the planar shape of the film type adhesive material 40, the hollow square pattern or the square pattern as shown in FIGS. 2A and 2B can be adopted, and the same idea as the first embodiment may be adopted. It is needed to design the planar shape in consideration of the relationship between the reduction in area of a portion damaging the circuit chip and the securement of the adhesion strength which are in trade-off relationship.

As described above, according to this embodiment, in the sensor device 110 in which the sensor chip 30 is stacked and adhesively attached onto the circuit chip 20 through the film type adhesive material 40, the thickness of the film type adhesive material 40 is set to be larger than the size of the foreign materials K1 occurring in the process of manufacturing the sensor device 110.

According to the sensor device 110, the thickness of the film type adhesive material 40 is set to be larger than the size of the foreign materials K1 occurring in the process of manufacturing the sensor device 110, and thus when the sensor chip 30 is pressurized so as to be pressed against the circuit chip 20, the foreign materials K1 are taken into the thick film type adhesive material 40, so that the stress applied from the foreign materials K1 to the circuit chip 20 can be greatly reduced.

Accordingly, in this embodiment, in the sensor device 110 in which the sensor chip 30 is stacked and adhesively attached onto the circuit chip 20, even when foreign materials intrude between the sensor chip 30 and the circuit chip 20, the circuit chip 20 serving as a base can be prevented from being damaged.

As described above, in the sensor device 110 of this embodiment, the thickness of the film type adhesive material 40 may be set to 20 μm or more.

### Other Embodiments

The first embodiment and the second embodiment may be combined with each other.

That is, the sensor device in which the sensor chip 30 is stacked and adhesively attached onto the circuit chip 20 through the film type adhesive material 40 may be designed so that the stress moderation film 60 is interposed between the circuit chip 20 and the film type adhesive material 40, and also the thickness of the film type adhesive material 40 is set to be larger than the size of each of foreign materials K1 occurring in the process of manufacturing the sensor device.

In the foregoing description, the acceleration sensor device is described as an exemplary sensor device. However, the invention is not limited to the acceleration sensor, and it may be applied to an angular velocity sensor, a pressure sensor, a temperature sensor, a humidity sensor, an optical sensor, an image sensor, etc.

That is, in the above embodiment, the sensor chip 30 may be an angular velocity detecting element, a pressure detecting element, a temperature detecting element, a humidity detecting element, an optical detecting element, an image detecting element or the like.

Furthermore, the circuit chip may be a circuit using MOS transistors, bipolar transistors or the like, a memory circuit or the like.

In short, the sensor device in which the sensor chip is stacked and adhesively attached onto the circuit chip through the film type adhesive material is characterized in that in order to enhance the resistance to foreign materials, the stress moderation film is interposed between the circuit chip and the film type adhesive material, and the thickness of the film type adhesive material is set to be larger than the size of the foreign materials, and the other constructions may be suitably modified in design.

What is claimed is:

1. A sensor device comprising:
a circuit chip and a sensor chip adhesively stacked on the circuit chip through a film type adhesive material; and
stress moderation film for moderating stress applied to the circuit chip, the stress moderation film being interposed between the circuit chip and the film type adhesive material.

2. The sensor device according to claim 1, wherein the stress moderation film is softer than the protection film coated on the surface of the circuit chip.

3. The sensor device according to claim 1, wherein the stress moderating film is formed of resin film.

4. A sensor device comprising a circuit chip and a sensor chip adhesively stacked on the circuit chip through a film type adhesive material, the thickness of the film type adhesive material being larger than the size of foreign materials occurring in a process of manufacturing the sensor device.

5. The sensor device according to claim 4, wherein the thickness of the film type adhesive material is set to 20 μm or more.
